(19) United States
(12) Patent Application Publication
(10) Pub. No.: US 2019/0130514 A1
(43) Pub. Date: May 2, 2019

(54) COMMUNICATIONS-BASED TRANSPORT

(71) Applicant: Walmart Apollo, LLC, Bentonville, AR (US)

(72) Inventors: Bruce W. Wilkinson, Rogers, AR (US); Sai Phaneendra Sri Harsha Viswanath Putcha, Bentonville, AR (US)

(21) Appl. No.: 16/178,422

(22) Filed: Nov. 1, 2018

Related U.S. Application Data
(60) Provisional application No. 62/580,546, filed on Nov. 2, 2017.

(51) Int. Cl. G06Q 50/28; G06Q 10/06

(52) U.S. Cl. CPC G06Q 50/28; G06Q 10/06398

(57) ABSTRACT

A control circuit facilitates third-party transportation of an item via a communications protocol. The control circuit receives from a first party a communication pertaining to a first item that is to be transported and then determines an acceptable transporter performance rating metric requirement for the first party as regards the first item. The control circuit uses that requirement to filter a candidate pool of third-party transporters to thereby identify at least one candidate third-party transporter. The control circuit assigns one of these candidates to transport the first item. The control circuit later automatically assesses transportation performance as regards the foregoing assignment and automatically updates a transporter performance rating metric for the assigned third-party transporter.

### CROSS-REFERENCE TO RELATED APPLICATION

This application claims the benefit of U.S. Provisional Application No. 62/580,546, filed Nov. 2, 2017, and is incorporated herein by reference in its entirety.

### TECHNICAL FIELD

These teachings relate generally to communications protocols and more particularly to communications-based transport of physical items.

### BACKGROUND

The physical transport of physical items from one location to another constitutes a well understood area of prior art endeavor. In those regards it is increasingly common for a physical item to be transported by one party for the benefit of another party. For example, military personnel may instruct other military personnel or civilian contractors to transport military supplies from a depot area to a frontline location. As another example, a civilian may order an item from a purveyor of such items and instruct that the item be delivered to their residence.

It is not unusual for the person arranging for such transport to specify a particular time of delivery. It is also not unusual for the person arranging for such transport to specify a particular third-party transporter to serve in these regards. Though often helpful and useful, however, existing opportunities in these regards do not necessarily meet the needs of all application settings.

### BRIEF DESCRIPTION OF THE DRAWINGS

The above needs are at least partially met through provision of the communications-based transport apparatus and method described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings; and

FIG. 3 comprises a call flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments a control circuit facilitates third-party transportation of an item via a communications protocol. The control circuit receives, from a first party and via a communications interface, a first communication pertaining to a first item. Generally speaking, this first item comprises an item that the first party wishes to have transported to a particular location. The control circuit then determines an acceptable transporter performance rating metric requirement for the first party as regards the first item. By one approach, for example, the control circuit makes this determination by receiving that requirement from the first party.

The control circuit then uses that acceptable transporter performance rating metric requirement to filter a candidate pool of third-party transporters to thereby identify at least one candidate third-party transporter. These teachings will also accommodate using other filtering criteria if desired. For example, the control circuit can make this identification as a further function of geographic locations of the third-party transporters. Upon identifying at least one candidate third-party transporter, the control circuit then conducts communications with one or more such candidates regarding transport of the first item to thereby identify an assignable third-party transporter. The control circuit then assigns the assignable third-party transporter as an assigned third-party transporter with an assignment comprising transportation of the first item.

The control circuit then automatically assesses transportation performance as regards the foregoing assignment and automatically updates a transporter performance rating metric for the assigned third-party transporter.

By one approach, these teachings will accommodate the control circuit providing to the assigned third-party transporter one or more transportation routes. In such a case, the control circuit can automatically assess the third-party transporter's transportation performance as a function of the route actually traversed by the third-party transporter when transporting the first item. So configured, the transporter performance rating metric can reflect an extent to which the third-party transporter respects and/or observes routing instructions. In that case, the aforementioned acceptable transporter performance rating metric requirement can itself constitute a requirement regarding how strictly the third-party transporter observes routing instructions.

Pursuant to these teachings, for example, a party requiring transport of a particular item can specify a requirement regarding routing compliance that is commensurate with relevant characteristics of the item itself. In some cases, the item and/or the first party's needs or plans for the item may be such that strict compliance with routing instructions is not especially important, in which case the requirements can reflect that permissible latitude. In other cases, when strict compliance with routing instructions is important, the aforementioned requirement can reflect that need.

These teachings will accommodate other transporter performance rating metric requirements as desired. Examples include but are not limited to timeliness requirements, time of day or day of week requirements, trust requirements, physical requirements (reflecting, for example, physical challenges presented by the delivery location), and so forth.

So configured, these teachings will support both use and automatic, dynamic updating of metrics regarding third-party transporters.

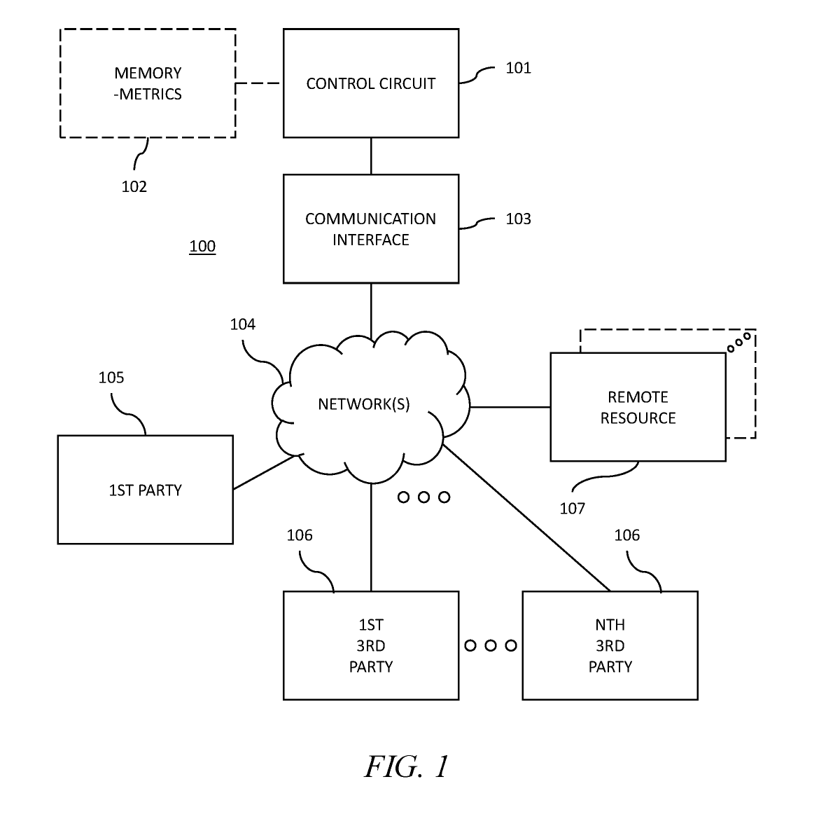

These and other benefits may become clearer upon making a thorough review and study of the following detailed description. Referring now to the drawings, and in particular to FIG. 1, an illustrative apparatus 100 that is compatible with many of these teachings will now be presented.

In this particular example, the enabling apparatus 100 includes a control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

By one optional approach the control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101).

In addition to information regarding transporter performance rating metrics and other data as described herein, this memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 101 also operably couples to a communications interface 103. So configured the control circuit 101 can communicate with other elements (both within the apparatus 100 and external thereto) via the communications interface 103. Communications interfaces, including both wireless and non-wireless platforms, are well understood in the art and require no particular elaboration here. The communications interface 103 communicatively couples to one or more networks 104 such as, but not limited to, the Internet and/or any of a variety of wireless communications networks. As will be described herein, this architecture permits the control circuit 101 to communicate with a first party 105, one or more third-party transporters 106, and also, if desired, one or more remote resources 107.

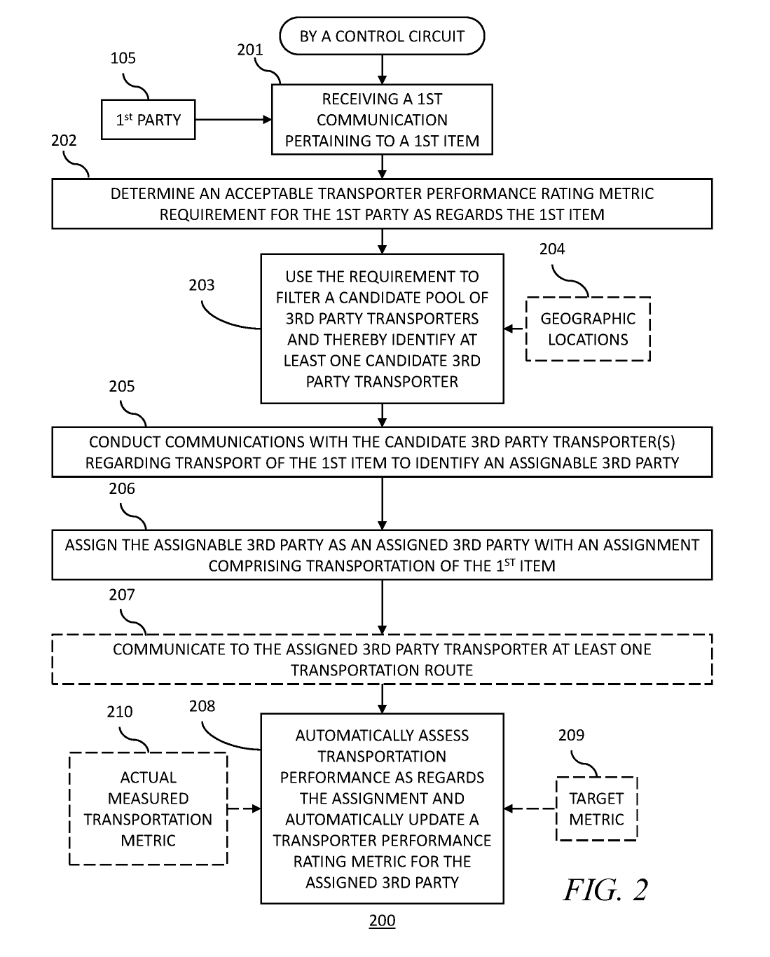

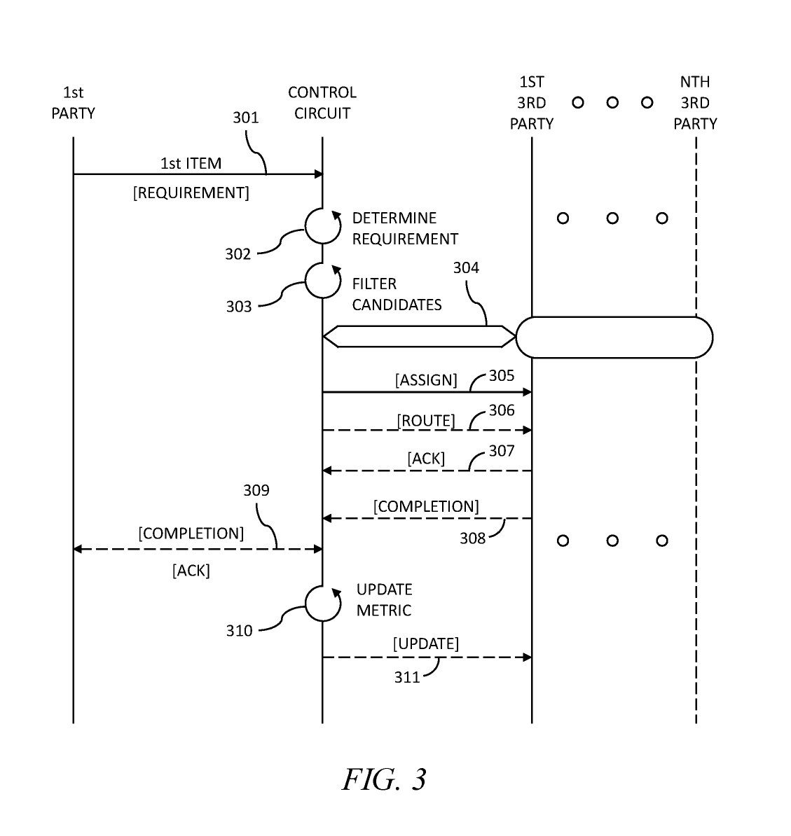

Referring now to FIGS. 2 and 3 and with continued reference to FIG. 1, an illustrative process 200 that is compatible with many of these teachings will now be presented. For the sake of an illustrative example it will be presumed here that the above-described control circuit 101 carries out the actions, steps, and/or functions of this process 200.

At block 201 control circuit 101 receives, from the aforementioned first party 105 and via the aforementioned communications interface 103, a first communication 301 pertaining to a first item. As used herein, the word “item” will be understood to refer to a physical item as versus, for example, a virtual item or a digital item (excepting where the virtual or digital item are themselves included within a physical item such as a physical tangible memory that is also to be transported). It will be understood that this first communication 301 can in fact pertain to a plurality of items. For the sake of clarity and simplicity, however, this description shall refer to only a single item.

This first communication 301 may constitute, for example, a message contained within a military context and where the item refers to a military item that the first party 105 wishes to have conveyed to a particular location. As another example, the first communication 301 may constitute a message contained within an emergency relief context and where the item refers to emergency relief supplies that the first party 105 wishes to have conveyed to a particular location. As yet another example, the first communication 301 may constitute a message contained within a commercial context and where the item refers to a purchased product that the first party 105 wishes to have conveyed to a particular location.

This first message 301 may contain any of a variety of informational content. Examples include identifying information for the first party 105, a destination address for the first item, authorization information, packaging requirements, time-of-delivery requirements, payment information, and so forth. In addition, and as shown in FIG. 3, this first message 301 may include requirements information regarding an acceptable transporter performance rating metrics requirement.

Such an acceptable transporter performance ratings metric requirement can serve to specify a minimum performance rating for the transporter who is to transport the first item. This performance rating constitutes a rating that represents past performance by the transporter when transporting other items. The “metric” itself can comprise, for example, a number on a scale of convenience (such as a scale of 0 to 5, a scale of 1 to 5 or 10, or a scale expressed using a particular number of icons of choice, such as stars, checkmarks, or the like, to note but a few examples in these regards).

At block 202, the control circuit 101 determines 302 an acceptable transporter performance rating metric requirement for the first party 105 as regards the first item. This requirement may reside, for example, within a profile for the first party 105 that is stored in the aforementioned memory 102. By another approach, and as described above, the first party 105 may include this requirement in the aforementioned first communication 301, in which case the control circuit 101 can make this determination by appropriately extracting that information from the first communication 301.

At block 203, the control circuit 101 uses the acceptable transporter performance rating metrics requirement to filter 303 a candidate pool of third-party transporters 106 to thereby identify at least one candidate third-party transporter 106 who meets the filtering requirements. As used herein, a “third party” will be understood to be a person or other entity (such as a business, agency, and so forth) that is neither the first party nor the party that operates and controls the control circuit 101. When the control circuit 101 is operated and controlled by, for example, a military service, the third-party transporter might comprise a civilian contractor. As another example, when the control circuit 101 is operated and controlled by or on behalf of a retailer, the third-party transporter might comprise a transport service that is otherwise unaffiliated with the retailer.

To facilitate this activity the aforementioned memory 102 can have information stored therein that correlates each of the plurality of third-party transporters in the candidate pool with a corresponding transporter performance rating metric. The acceptable transporter performance rating metrics requirement that corresponds to the first party 105 as regards the first item can therefore serve as a standard to exclude any third-party transporters in the candidate pool who do not measure up to that standard in terms of their past performance.

These teachings will accommodate employing other filter criteria as well to further vet the third-party transporters in the candidate pool. As one example in these regards, the control circuit 101 can filter the candidate pool of third-party transporters as a function of geographic location information 204. Examples of useful geographic location information include but are not limited to current and/or future scheduled geographic locations for some or all of the third-party transporters. The control circuit 101 can employ such information to filter out any third-party transporters who are not, or who will not be, within a predetermined distance of a point of origin for the first item in order to reduce overall cycle time for completing transport of the first item per the first party's instructions.

By so filtering the candidate pool of third-party transporters, the control circuit 101 identifies at least one candidate third-party transporter. At block 205, the control circuit 101 conducts communications 304 (via the communications interface 103) with the at least one candidate third-party transporter to facilitate identifying an assignable third-party transporter. These communications 304 may serve, for example, to determine which of the candidate third-party transporters are available during the necessary time window to facilitate transporting the first item.

These communications 304 may also serve to accommodate any other vetting activities and/or negotiations that may be appropriate or necessary. For example, if handling of the first item requires a particular level of security clearance, these communications 304 can provide a mechanism by which the candidate third-party transporters communicate or confirm their corresponding credentials in these regards.

The control circuit 101 then selects a particular one of the candidate third-party transporters as an assignable third-party transporter. At block 206 the control circuit sends a message 305 to the assignable third-party transporter to assign the assignable third-party transporter with an assignment to transport the first item. Depending upon the information already provided per the foregoing communications, this assignment message 305 may or may not include specific information regarding the timing particulars of the assigned transportation task, the point of origin where the first item can be picked up, the destination address, information regarding the intended recipient, and other details and requirements regarding the transportation task.

By one optional approach, the control circuit 101, at block 207, may send a message 306 to the assigned third-party transporter comprising one or more approved and/or required transportation routes to employ when transporting the first item. The transportation route instructions may be as general or as specific as desired. For example, general instructions might only stipulate taking a route that passes through a particular town while specific instructions might comprise so-called turn-by-turn instructions for the entire route.

These teachings will readily accommodate other expected or optional communications within the illustrated protocol. For example, the assigned third-party transporter may send an acknowledgment message 307 to the control circuit 101 to acknowledge receipt of one or more of the foregoing messages. As another example, the assigned third-party transporter may send a completion message 308 to the control circuit 101 upon completing delivery of the first item and hence completion of the transportation task. As yet another example, the first party may send completion and/or acknowledgment messages 309 to the control circuit 101 as appropriate.

At block 208 the control circuit 101 automatically assesses transportation performance as regards the above-described assignment and automatically updates 310 a transporter performance rating metric for the assigned third-party transporter. This assessment can be undertaken as a function, for example, of comparing a target metric 209 against an actual measured transportation metric 210 that corresponds to this particular transportation task. As one simple example in these regards, the target metric 209 may constitute a period of time such as a particular number of minutes and the actual measured transportation metric 210 may constitute the amount of time taken by the assigned third-party transporter to begin and complete the assigned transportation task.

As another example, as noted above these teachings will accommodate providing the assigned third-party transporter with one or more approved and/or required routes. Presuming the control circuit 101 has access to information regarding the particular route traversed by the third-party transporter when completing the transportation task, that information can be compared against the approved/required route(s) to assess a degree of compliance or variance. The resultant transporter performance rating metric can be updated to reflect the degree to which the third-party transporter complied or did not comply with such routing requirements.

By one optional approach, the control circuit 101 can transmit a message 311 to the assigned third-party transporter to inform the latter of the above-described assessment and/or update results. If desired, these teachings will accommodate a review process to permit an assigned third-party transporter to challenge an assessment/update that they consider to be incorrect.

So configured, these teachings can greatly facilitate identifying and selecting third-party transporters who are likely to suit the needs and expectations of a party who seeks to arrange for transport of a physical item. In particular, the filtering process can make use of continually and automatically updated information regarding the performance of candidate third-party transporters to help ensure the freshness and/or accuracy of that information.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus to facilitate third-party transportation of an item, the apparatus comprising:
a communications interface operably coupled to at least one communications network;
a control circuit operably coupled to the communications interface and configured to:
receive, from a first party and via the communications interface, a first communication pertaining to a first item;
determine an acceptable transporter performance rating metric requirement for the first party as regards the first item;
use the acceptable transporter performance rating metric requirement to filter a candidate pool of third-party transporters and thereby identify at least one candidate third-party transporter;
conduct communications with the at least one candidate third-party transporter and via the communication interface regarding transport of the first item to identify an assignable third-party transporter;
assign the assignable third-party transporter as an assigned third-party transporter with an assignment comprising transportation of the first item;
automatically assess transportation performance as regards the assignment and automatically updating a transporter performance rating metric for the assigned third-party transporter.

2. The apparatus of claim 1 wherein the at least one communications network comprises a wireless communications network.

3. The apparatus of claim 1 wherein the control circuit is configured to automatically assess the transportation performance as regards the assignment by comparing an actual measured transportation metric against a target metric.

4. The apparatus of claim 3 wherein the actual measured transportation metric comprises an actual measurement of time for transporting the first item.

5. The apparatus of claim 3 wherein the control circuit is further configured to:
communicate to the assigned third-party transporter, via the communications interface, at least one transportation route.

6. The apparatus of claim 5 wherein the actual measured transportation metric corresponds to a route actually traversed by the third-party transporter when transporting the first item.

7. The apparatus of claim 1 wherein the control circuit is configured to determine the acceptable transporter performance rating metric requirement for the first party by receiving the acceptable transporter performance rating metric requirement, via the communications interface, from the first party.

8. The apparatus of claim 1 wherein the control circuit is further configured to:
filter the candidate pool of third-party transporters to thereby identify at least one candidate third-party transporter as a further function of geographic locations of the third-party transporters.

9. The apparatus of claim 8 wherein the geographic locations comprise current geographic locations.

10. The apparatus of claim 8 wherein the geographic locations comprise future scheduled geographic locations.

11. A method to facilitate third-party transportation of an item, the method comprising:
by a control circuit that is operably coupled to a communications interface that is operably coupled to at least one communications network:
receiving, from a first party and via the communications interface, a first communication pertaining to a first item;
determining an acceptable transporter performance rating metric requirement for the first party as regards the first item;
using the acceptable transporter performance rating metric requirement to filter a candidate pool of third-party transporters and thereby identify at least one candidate third-party transporter;
conducting communications with the at least one candidate third-party transporter and via the communication interface regarding transport of the first item to identify an assignable third-party transporter;
assigning the assignable third-party transporter as an assigned third-party transporter with an assignment comprising transportation of the first item;
automatically assessing transportation performance as regards the assignment and automatically updating a transporter performance rating metric for the assigned third-party transporter.

12. The method of claim 11 wherein automatically assessing the transportation performance as regards the assignment comprises comparing an actual measured transportation metric against a target metric.

13. The method of claim 11 wherein the actual measured transportation metric comprises an actual measurement of time for transporting the first item.

14. The method of claim 11 further comprising:
communicating to the assigned third-party transporter, via the communications interface, at least one transportation route;
and wherein the actual measured transportation metric corresponds to a route actually traversed by the third-party transporter when transporting the first item.

15. The method of claim 11 wherein determining the performance requirement for the first party comprises receiving the acceptable transporter performance rating metric requirement, via the communications interface, from the first party.

16. The method of claim 11 further comprising:
filtering the candidate pool of third-party transporters and thereby identifying at least one candidate third-party transporter as a further function of geographic locations of the third-party transporters.

17. The method of claim 16 wherein the geographic locations comprise current geographic locations.

18. The method of claim 16 wherein the geographic locations comprise future scheduled geographic locations.

19. An apparatus to facilitate third-party transportation of an item, the apparatus comprising:
a communications interface operably coupled to at least one communications network;
a control circuit operably coupled to the communications interface and configured to:
receive, from a first party and via the communications interface, a first communication pertaining to a first item;
determine at least one acceptable transporter performance rating metric requirement for the first party as regards the first item, wherein the at least one transporter performance rating metric represents past performance by the transporter when transporting other items regarding timeliness, availability, physicality, and an extent to which the transporter observes routing instructions;
use the acceptable transporter performance rating metric requirement to filter a candidate pool of third-party transporters and thereby identify at least one candidate third-party transporter;
conduct communications with the at least one candidate third-party transporter and via the communication interface regarding transport of the first item to identify an assignable third-party transporter;
assign the assignable third-party transporter as an assigned third-party transporter with an assignment comprising transportation of the first item;
automatically assess transportation performance as regards the assignment and automatically updating a transporter performance rating metric for the assigned third-party transporter.
